(19) United States
(12) Patent Application Publication
(10) Pub. No.: US 2024/0344380 A1
(43) Pub. Date: Oct. 17, 2024

(54) POWERED DRIVE UNIT WITH INTEGRATED COUNTERBALANCE

(71) Applicant: MAGNA CLOSURES INC., Newmarket (CA)

(72) Inventors: Dunia SARDELLI, Newmarket (CA); Luca FARNESI, Newmarket (CA)

(21) Appl. No.: 18/625,190

(22) Filed: Apr. 2, 2024

Related U.S. Application Data
(60) Provisional application No. 63/458,724, filed on Apr. 12, 2023.

(51) Int. Cl. E05F 15/611; E05F 1/12

(52) U.S. Cl. CPC E05F 15/611; E05F 1/1261; E05Y 2600/46; E05Y 2900/544; E05Y 2900/546

(57) ABSTRACT

A powered actuator for moving a motor vehicle closure member from a closed position to an open position and method of facilitating movement of the closure member therewith. Powered actuator includes an electric motor configured to rotate a driven shaft and a gearbox coupled to the driven shaft. An extensible member extends through the gearbox to a proximal end on one side of the gearbox for attachment to one of a vehicle body or the closure member and to a distal end on an opposite side of the gearbox. Extensible member is configured to move between retracted and extended positions in response to rotation of the driven shaft. A bias member is configured to impart an axially directed bias on the extensible member to facilitate controlled movement of the extensible member, while reducing the load imparted on the electric motor and the gearbox during powered movement of the closure member between the open and closed positions.

### CROSS-REFERENCE TO RELATED APPLICATION

This application claims the benefit of U.S. Provisional Application Ser. No. 63/458,724, filed Apr. 12, 2023, which is incorporated herein by reference in its entirety.

### FIELD

The present disclosure relates to a power actuator for a vehicle closure. More specifically, the present disclosure relates to a power actuator assembly for a vehicle closure member.

### BACKGROUND

This section provides background information related to the present disclosure which is not necessarily prior art.

Closure members of motor vehicles may be mounted by one or more hinges to the vehicle body. For example, tailgates, passenger doors, and rear hatches may be oriented and attached to the vehicle body by the one or more hinges for swinging movement about a pivot axis. In such an arrangement, each door hinge typically includes a closure member hinge strap connected to the closure member, a body hinge strap connected to the vehicle body, and a pivot pin arranged to pivotably connect the closure member hinge strap to the body hinge strap and define a pivot axis. Such swinging closure members may be moveable by power closure member actuation systems. Specifically, the power closure member system can function to automatically swing the closure member about its pivot axis between the open and closed positions, to assist the user as the user moves the closure member, and/or to automatically move the closure member between closed and open positions for the user.

Typically, power closure member actuation systems include a power-operated device such as, for example, an electric motor and a rotary-to-linear conversion device that are operable for converting the rotary output of the electric motor into translational movement of an extensible member. The electric motor and the conversion device are typically mounted to the closure member and an end of the extensible member is typically secured to the vehicle body. One example of a power closure member actuation system for a passenger door is shown in commonly-owned International Publication No. WO2013/013313 to Scheuring et al. which discloses use of a rotary-to-linear conversion device having an externally-threaded leadscrew rotatively driven by the electric motor and an internally-threaded drive nut meshingly engaged with the leadscrew and to which the extensible member is attached. Control over the speed and direction of rotation of the leadscrew results in control over the speed and direction of translational movement of the drive nut and the extensible member for controlling swinging movement of the closure member between its open and closed positions. The entire force provided to move the closure member between its open and closed positions is provided by the electric motor. Although suitable for its intended function, the size of the electric motor must be sufficiently large to provide the force needed to move the closure member between its open and closed positions. Further yet, the stress applied to the electric motor by counteracting forces from the closure member, including excess forces generated by wind and gravity, can cause accelerated wear to the electric motor and other components, including the drive nut and leadscrew, thereby diminishing the useful life of the power closure member actuation system.

In view of the above, there remains a need to develop power closure member actuation systems which address and overcome limitations and drawbacks associated with known power closure member actuation systems as well as to provide increased convenience and enhanced operational capabilities.

### SUMMARY

This section provides a general summary of some of the objects, advantages, aspects and features provided by the inventive concepts associated with the present disclosure. However, this section is not intended to be considered an exhaustive and comprehensive listing of all such objects, advantages, aspects and features of the present disclosure.

In one aspect, the present disclosure is directed to a vehicle closure panel and a powered actuator for the vehicle closure panel which advances the art and improves upon currently known vehicle closure panels and powered actuators for such vehicle closure panels.

In another aspect, the present disclosure is directed to a method of constructing a powered actuator for a closure panel of a motor vehicle which advances the art and improves upon currently known methods of constructing powered actuators for vehicle closure panels.

In accordance with these and other aspects, a powered actuator for moving a closure member of a motor vehicle between a closed position and an open position includes an electric motor configured to rotate a driven shaft. A gearbox is coupled to the driven shaft. A gearbox housing encloses the gearbox. An extensible member extends through the gearbox and has a proximal end on one side of the gearbox and a distal end on an opposite side of the gearbox. The distal end is configured to be pivotably coupled to one of a vehicle body or the closure member. The extensible member is configured to move between a retracted position, corresponding to the closed position of the closure member, and an extended position, corresponding to the open position of the closure member, in response to rotation of the driven shaft. A bias member is configured to impart an axially directed bias on the extensible member to facilitate controlled axial movement of the extensible member, while reducing the load imparted on the electric motor and the gearbox during powered movement of the closure member between the open and closed positions.

In accordance with another aspect of the disclosure, the bias member is in a compressed state when the extensible member is in one of the retracted position or the extended position, and wherein the bias member is in a decompressed state when the extensible member is in the other of the retracted position or the extended position.

In accordance with another aspect of the disclosure, the bias member can be configured to be in the compressed state when the extensible member is in the retracted position, whereat the bias member exerts a bias on the extensible member to facilitate moving the closure member from the closed position to the open position.

In accordance with another aspect of the disclosure, the bias member can be disposed between the gearbox housing and the distal end of the extensible member.

In accordance with another aspect of the disclosure, the bias member can be provided as a coil spring disposed about the extensible member.

In accordance with another aspect of the disclosure, the bias member can be configured to be in the compressed state when the extensible member is in the extended position, whereat the bias member exerts a bias on the extensible member to facilitate supporting weight of the closure member as the closure member moves from the closed position toward the open position.

In accordance with another aspect of the disclosure, the bias member can be disposed between the gearbox housing and the proximal end of the extensible member.

In accordance with another aspect of the disclosure, a motor vehicle having a closure member moveable between open and closed positions has a powered actuator for moving the closure member between the closed position and the open position. The powered actuator includes an electric motor configured to rotate a driven shaft, a gearbox coupled to the driven shaft, an extensible member extending through the gearbox and having a proximal end on one side of the gearbox and a distal end on an opposite side of the gearbox. The distal end is configured to be pivotably coupled to one of a vehicle body of the motor vehicle or the closure member. The extensible member is configured to move between a retracted position relative to the gearbox, corresponding to the closed position of the closure member, and an extended position relative to the gearbox, corresponding to the open position of the closure member, in response to rotation of the driven shaft. A bias member is arranged to impart an axially directed bias on the extensible member to facilitate controlled axial movement of the extensible member, while reducing the load imparted on the electric motor and the gearbox, during powered movement of the closure member between the open and closed positions.

In accordance with another aspect of the disclosure, a method of facilitating movement of a closure member between and open position and a closed position with a powered actuator having an electric motor configured to rotate a driven shaft is provided. The method includes coupling a gearbox to the driven shaft; enclosing the gearbox with a gearbox housing; extending an extensible member through the gearbox with a proximal end of the extensible member being on one side of the gearbox and a distal end of the extensible member being on another side of the gearbox; configuring the distal end to be pivotably coupled to one of a vehicle body or the closure member; configuring the extensible member to move in response to rotation of the driven shaft between a retracted position, corresponding to the closed position of the closure member, and an extended position, corresponding to the open position of the closure member; and imparting an axially directed bias on the extensible member with a bias member to facilitate controlled axial movement of the extensible member between the retracted and extended positions.

In accordance with another aspect of the disclosure, the method can further include providing the bias member being configured to be compressed as the closure member is moved toward the open position.

In accordance with another aspect of the disclosure, the method can further include providing the bias member being configured to be compressed as the closure member is moved toward the closed position.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. Other advantages of the present embodiments than discussed expressly herein will be readily appreciated, as the same becomes better understood by reference to the following detailed description and appended claims when considered in connection with the accompanying drawings, wherein:

FIG. 1A is a rear fragmentary perspective view of an example motor vehicle equipped with a power closure member actuation system situated between a tailgate and a vehicle body, according to aspects of the disclosure;

FIG. 1B is a rear fragmentary perspective view of an example motor vehicle equipped with a power closure member actuation system situated between a liftgate and a vehicle body, according to aspects of the disclosure;

FIG. 2A is a side view of a power closure member of FIG. 1A, with a portion of an extensible member housing of a power drive unit of the power closure member actuation system broken away for clarity purposes only, with an extensible member of the power drive unit shown in a retracted position corresponding to a closed position of the tailgate;

FIG. 2B is a view similar to FIG. 2A, with the extensible member of the power drive unit shown in an extended position corresponding to an open position of the tailgate;

FIG. 3A is a side view of a power closure member of FIG. 1B, with an extensible member of a power drive unit of the power closure member actuation system shown in a retracted position corresponding to a closed position of the liftgate;

FIG. 3B is a view similar to FIG. 3A, with the extensible member of the power drive unit shown in an extended position corresponding to an open position of the liftgate; and

FIG. 4 illustrates a method of facilitating operation of a power drive unit configured to move a closure member between open and closed positions.

Corresponding reference numerals indicate corresponding parts throughout the several views of the drawings.

### DETAILED DESCRIPTION OF EXAMPLE EMBODIMENTS

One or more example embodiments of a powered closure member of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

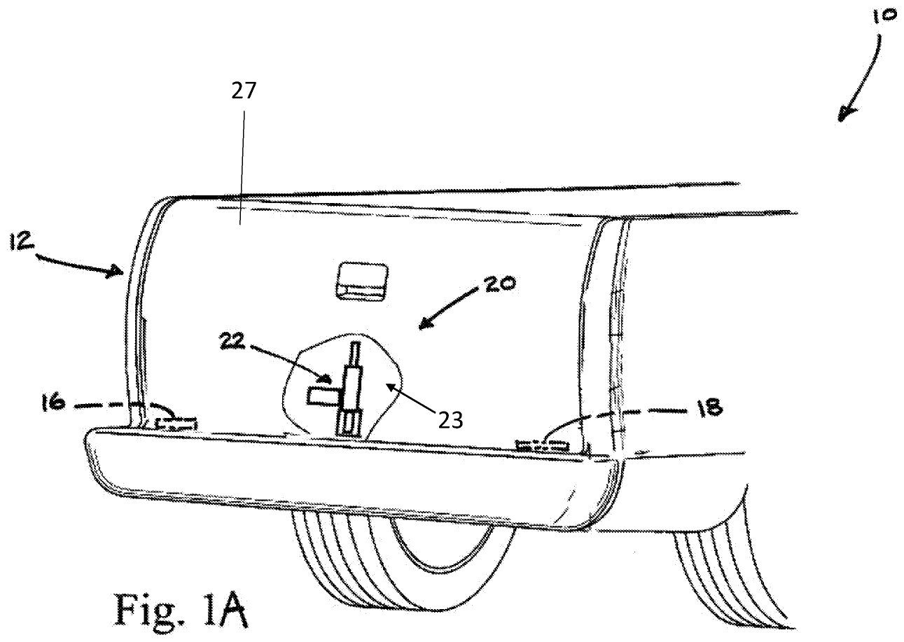

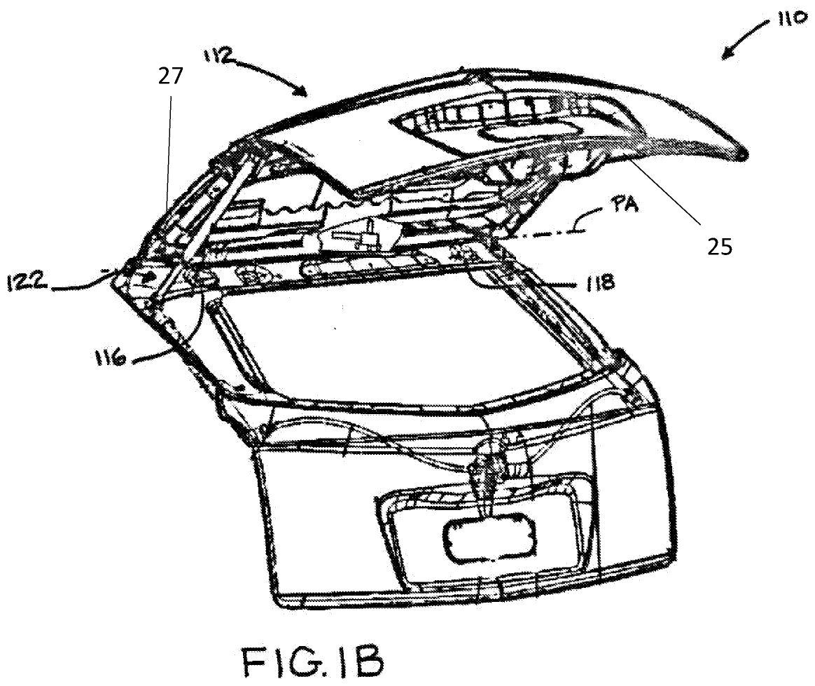

Referring initially to FIG. 1A, an example motor vehicle 10 is shown to include a closure member 12, illustrated as a tailgate, by way of example and without limitation, pivotally mounted to a vehicle body 14 via a pair of hinges 16, 18 which are shown in phantom lines. In accordance with the present disclosure, a power closure member actuation system 20 includes a power drive unit, also referred to as power-operated actuator mechanism or actuator 22 pivotally connected between closure panel 12 and the vehicle body 14. In accordance with a preferred configuration, power-operated actuator mechanism or actuator 22 is disposed and secured within an internal cavity of closure panel 12, and a rotary drive mechanism that is driven by the power-operated actuator mechanism 22 is drivingly coupled to the vehicle body 14. The internal cavity 23 is illustratively defined by inner 25 and outer panels 27 of the closure panel. Driven rotation of the rotary drive mechanism causes controlled pivotal movement of passenger door 12 relative to vehicle body 14. In accordance with this preferred configuration, the power-operated actuator mechanism 22 is pivotally coupled to the closure panel 12 between hinges 16, 18, while the rotary drive mechanism is pivotally coupled to the vehicle body 14. However, those skilled in the art will recognize that alternative packaging configurations for power closure member actuation system 20 are available to accommodate available packaging space. One such alternative packaging configuration may include mounting the power-operated actuator mechanism 22 to vehicle body 14 and drivingly interconnecting the rotary drive mechanism to the closure panel 12.

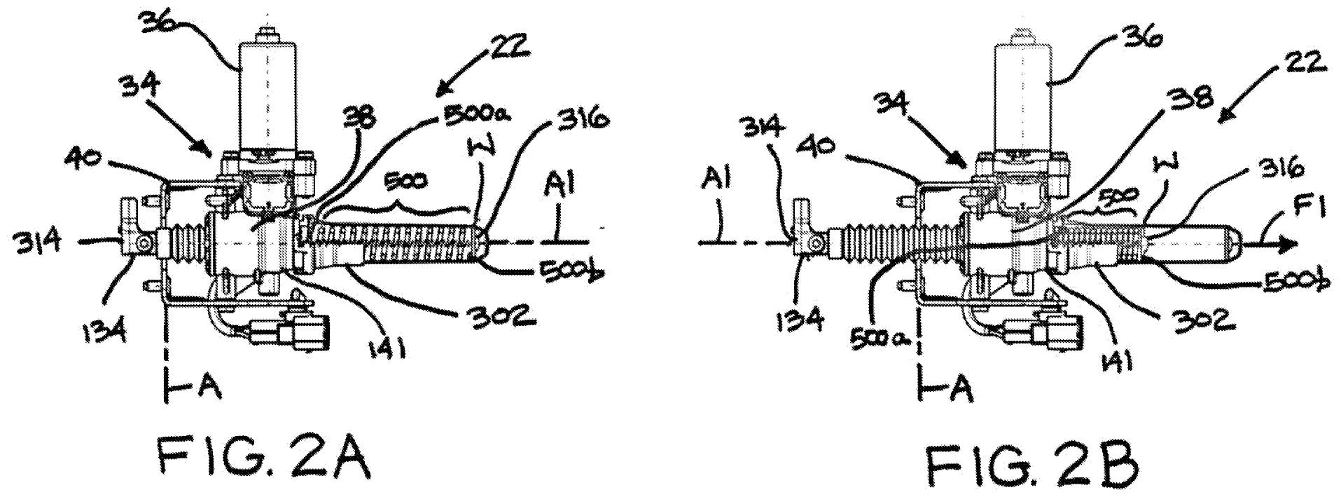

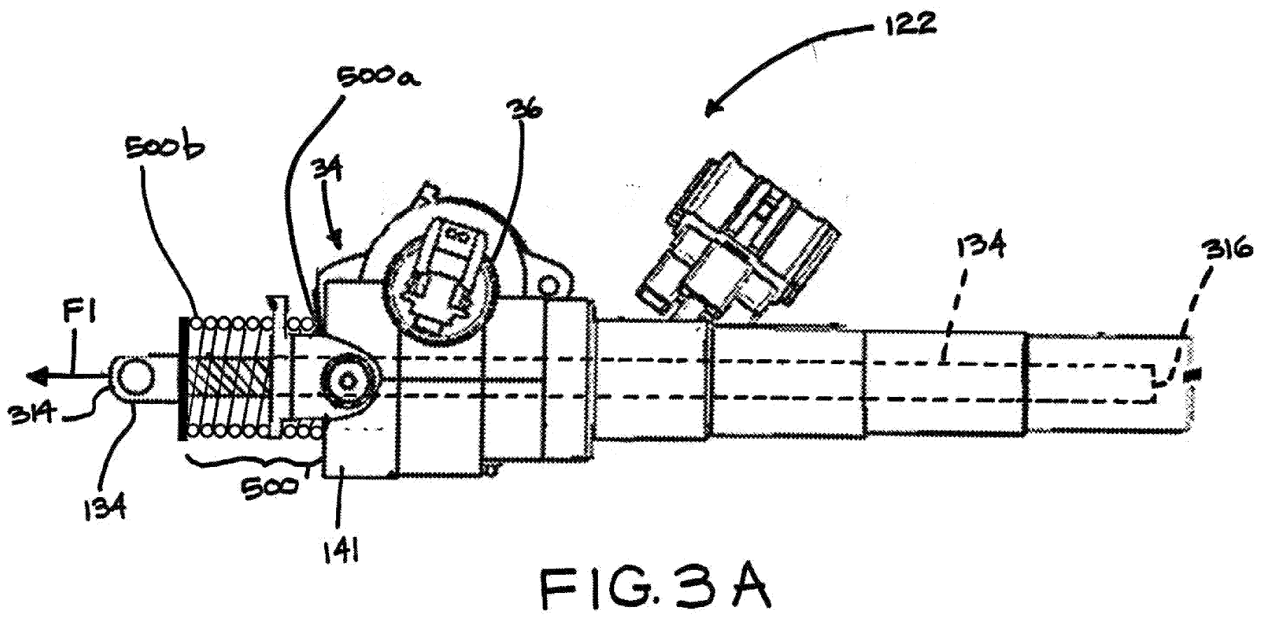

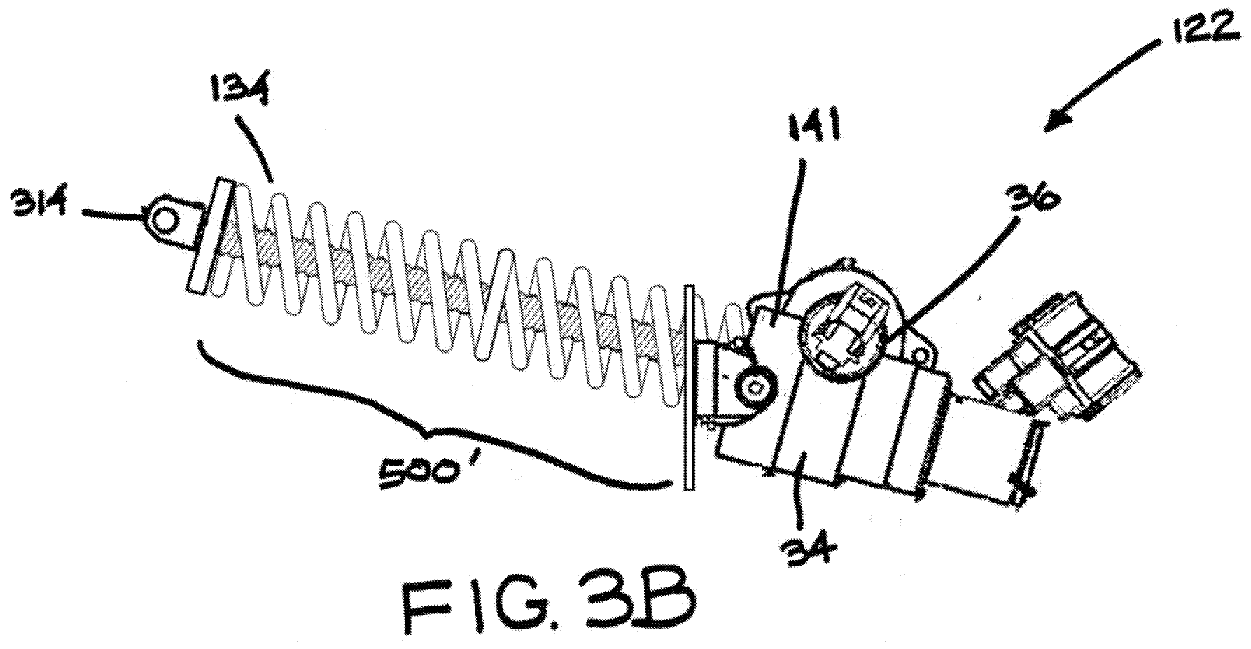

As best shown in FIGS. 2A and 2B, power-operated actuator mechanism 22 has a motor and geartrain assembly 34 that is connectable to closure member 12. Motor and geartrain assembly 34 is configured to generate a rotational force about pivot axis A. In the preferred embodiment, motor and geartrain assembly 34 includes an electric motor 36 that is operatively coupled to a speed reducing/torque multiplying assembly 38, as a gearbox having one or more stages with a gear ratio allowing motor and geartrain assembly 34 to generate a rotational force having a high torque output by way of a very low rotational speed of electric motor 36. However, any other arrangement of motor and geartrain assembly 34 can be used to establish the required rotational force without departing from the scope of the subject disclosure. Electrical motor 36 is controlled by electronics, which may include a microprocessor 110 and power electronics 92, such as H-bridge, FETS for example, controlled by the microprocessor 110, as disclosed in co-owned U.S. patent application Ser. No. 17/206,198, published as Publication No. 2021/0293071 (the '071 publication), Sep. 23, 2021, which is incorporated by way of reference in its entirety herein.

Motor and geartrain assembly 34 includes a mounting bracket 40 for establishing the connectable relationship with closure member 12 and the actuator 22, as thoroughly discussed in the '071 publication. Power closure member actuation system 20 further includes the rotary drive mechanism that is rotatively driven by the power-operated actuator mechanism 22. FIGS. 2A and 2B show the general arrangement of the gearbox 38, which is configured to drive an extensible member 134 between a retracted position (FIG. 2A), whereat closure member 12 is moved to its closed position, and an extended position (FIG. 2B), whereat closure member 12 is moved to its open position.

Gearbox 38 includes a lead nut (shown in appended '071 publication) disposed in threaded engagement with the extensible member 134 that is formed as a leadscrew. Extensible member 134 is driven by rotation of the lead nut such that the lead nut remains fixed against axial translation relative to the gearbox 38, while the extensible member 134 translates linearly through gearbox 38 when lead nut is rotated, such that extensible member 134 translated linearly relative to the gearbox 38 between its retracted and extended positions.

A cover 302, broken away and partially illustrated in FIGS. 2A and 2B for clarity purposes only, is attached to the gearbox 38 and is configured to enclose the extensible member 134 on one side of gearbox 38 to prevent contamination from reaching extensible member 134. The cover 302 is formed as a hollow tubular member, such as having a cylindrical geometry or otherwise. The cover 302 is illustratively a light weight non-load bearing structure for supporting the weight of the gearbox 140 and motor 36, and in other words, the cover 302 does not support the weight of the motor 36 and/or gearbox 140. Cover 302 may be made from rubber, plastic, or a lightweight metal, such as aluminum, for example.

The power-operated actuator mechanism 22 includes an integrated counterbalancing bias member, referred to hereafter as bias member 500, configured to impart an axially directed bias on extensible member 134 along a longitudinal along axis A1 of extensible member 134 to facilitate controlled axial movement of extensible member 134, thereby reducing the load imparted on electric motor 36 and gearbox 38 during powered movement of closure member 12. Accordingly, the effort (power) required by electrical motor 36 to effect movement of extensible member 134 is reduced, thereby being able to reduce the size, weight, and cost of electric motor 36.

The bias member 500 is in a compressed state, corresponding to an energy storing state), when the extensible member 134 is in one of the retracted position or the extended position, and the bias member 500 is in a decompressed state (corresponding to an energy exhausted state), when the extensible member 134 is in the other of the retracted position or the extended position. In accordance with one aspect, as shown in FIG. 2A, the bias member 500 is in the energy dissipated, decompressed state when the extensible member 134 is in the retracted position, whereat the closure member, shown as tailgate 12, is in the closed position. Meanwhile, as shown in FIG. 2B, the bias member 500 is moved to the energy storing, compressed state when the extensible member 134 is in the extended position, whereat the closure member, shown as tailgate 12, is in the open position. While moving toward, and while in the compressed state, the bias member 500 exerts a counterforce F1 (bias), acting in an opposite direction to a force (weight) generated by gravity acting on closure member 12, on the extensible member 134 to facilitate supporting the weight of the closure member 12, such as tailgate of FIG. 1A, as the closure member 12 moves from the closed position (vertically upright) toward the open position (horizontal), and while closure member 12 is in its fully open position. The counterforce F1 acts to reduce the load applied on the gearbox 38 and on the electric motor 36, thereby increasing their operating efficiency and extending their useful life, as discussed above.

As shown in FIGS. 2A and 2B, the bias member 500 is disposed between the gearbox housing 141 and the proximal end 316 of the extensible member 134. The bias member 500 can be provided as a generally cylindrical coil spring disposed about the extensible member 134, with one end 500a of the bias member 500 being biased into engagement with the gearbox housing 141 and an opposite end 500b of the bias member 500 being operably fixed to the extensible member 134, shown as being operably fixed to the extensible member 134 via an end stop, such as a fixed washer W, adjacent to or at the proximal end 316. Bias member end 500b is maintained in abutment with end stop W as a result of bias member 500 being compressed from its fully relaxed stated between end stop W and gearbox housing 141, even when bias member 500 is in its decompressed state. Accordingly, even when bias member 500 is in its decompressed stated, a slight load is applied along bias member 500 to keep it from being in a fully decompressed, relaxed state, thereby eliminating a source of rattle and noise generation.

In accordance with another aspect, example motor vehicle 110 has a closure member 112, shown as a liftgate, by way of example and without limitation, pivotally mounted to a vehicle body 114 via a pair of hinges 116, 118 and supported for pivotal movement about a pivot axis PA between closed and open positions by a power-operated actuator mechanism 122. As liftgate 112 is moved toward its open position, actuator 122 must exert and sustain a force sufficient to support and push the weight of liftgate 112 upwardly against a downward acting gravitational force on liftgate 112. To facilitate exerting and sustaining such force, as shown in FIG. 3A, a bias member 500′ of actuator 122 is in the energy storing, compressed state when the extensible member 134 is in the retracted position, whereat the closure member 112 is in the closed position. Accordingly, while closure member 112 is closed, bias member 500′ is compress and loaded to exert a bias force F1 directed along a direction tending to assist in moving closure member 112 toward its open position. As shown in FIG. 3B, the bias member 500′, shown schematically, is moved to its energy dissipated, decompressed state when the extensible member 134 is in the extended position, whereat the bias member 500′ exerts a bias F1 on an end stop, such as a washer W, and on gearbox housing 141, thereby applying force F1 on the extensible member 134 to facilitate holding the closure member 112 in the open position against the downwardly acting gravitational force. It is to be recognized that as extensible member 134 is moving from its retracted position toward its extended position under powered actuation by electric motor 36, the bias member 500′ exerts bias force F1 on extensible member 134, thereby assisting electric motor 36 in moving liftgate 112 toward its open position, and thus, reducing the output load needed from electric motor 36 to perform the opening movement of liftgate 112.

As shown in FIGS. 3A and 3B, the bias member 500′ is disposed between the gearbox housing 141 and the distal end 314 of the extensible member 134. The bias member 500′ can be provided as a coil spring disposed and wrapped helically about the extensible member 134, as discussed above for bias member 500, with one end 500a of the bias member 500′ being biased into engagement with the gearbox housing 141 and an opposite end 500b of the bias member 500′ being operably fixed to the extensible member 134, shown as being fixed in abutment with end stop W, thereby being operably fixed to extensible member 134 adjacent to or at the distal end 314. As discussed above for bias member 500, bias member 500′ is maintained under a slight axial compression even when in its decompress state, thereby eliminating a potential source of rattle and noise.

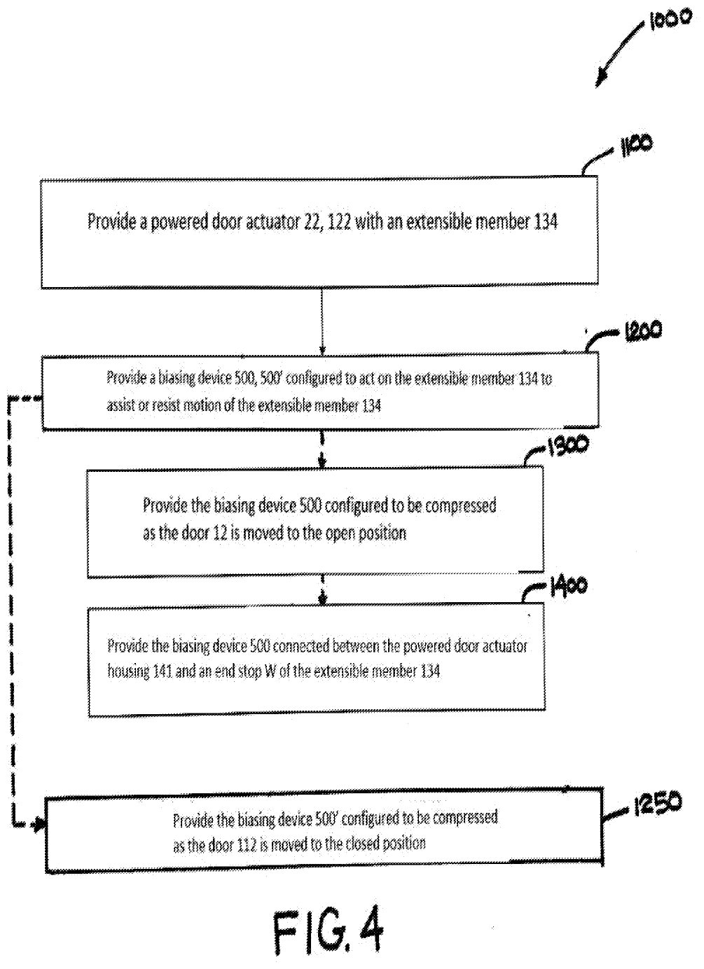

FIG. 4 illustrates a method 1000 of facilitating movement of a closure member 12, 112 between an open position and a closed position with a powered actuator 22, 122 having an electric motor 36 configured to rotate a driven shaft 166. The method 1000 includes coupling a gearbox 38 to the driven shaft 166 and enclosing the gearbox 38 with a gearbox housing 141. Further, a step 1100 of extending an extensible member 134 through the gearbox 38 with a proximal end 316 of the extensible member 134 being on one side of the gearbox 38 and a distal end 314 of the extensible member 134 being on an opposite side of the gearbox 38. Further, configuring the distal end 314 to be pivotably coupled to one of a vehicle body 14 or the closure member 12 and configuring the extensible member 134 to move in response to rotation of the driven shaft 166 between a retracted position, corresponding to the closed position of the closure member 12, 112, and an extended position, corresponding to the open position of the closure member 12, 112. Further, a step 1200 of providing and imparting an axially directed bias on the extensible member 134 with a bias member 500, 500′ to facilitate controlled axial movement of the extensible member 134 between the retracted and extended positions. The controlled axial movement of the extensible member 134 can be facilitated by assisting movement of the extensible member 134 in the intended direction, or resisting axial movement of the extensible member 134 in an unintended direction. The method 1000 can further include a step 1300 of providing the bias member 500 being configured to be compressed (FIG. 2B) as the closure member 12 is moved toward, and to the open position. The method 1000 can further include a step 1400 of providing the bias member 500 being connected between the gearbox housing 141 and an end stop W of the extensible member 134. Otherwise, instead of step 1300, the method 1000 can include a step 1250 of providing the bias member 500′ being configured to be compressed (FIG. 3A) as the closure member 112 is moved toward and to the closed position.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A powered actuator for moving a closure member of a motor vehicle between a closed position and an open position, comprising:
an electric motor configured to rotate a driven shaft;
a gearbox coupled to said driven shaft;
a gearbox housing enclosing the gearbox;
an extensible member extending through said gearbox and having a proximal end on one side of said gearbox and a distal end on an opposite side of said gearbox, said distal end being configured to be pivotably coupled to one of a vehicle body or the closure member, said extensible member being configured to move between a retracted position relative to said gearbox, corresponding to the closed position of the closure member, and an extended position relative to said gearbox, corresponding to the open position of the closure member, in response to rotation of the driven shaft; and
a bias member configured to impart an axially directed bias on said extensible member to facilitate controlled axial movement of said extensible member, while reducing the load imparted on said electric motor and said gearbox, during powered movement of the closure member between the open and closed positions.

2. The power actuator of claim 1, wherein said bias member is in a compressed state when said extensible member is in one of the retracted position or the extended position, and wherein said bias member is in a decompressed state when said extensible member is in the other of the retracted position or the extended position.

3. The power actuator of claim 2, wherein said bias member is in the compressed state when said extensible member is in the retracted position, whereat said bias member exerts a bias on said extensible member to facilitate moving the closure member from the closed position to the open position.

4. The power actuator of claim 3, wherein said bias member is disposed between said gearbox housing and said distal end of said extensible member.

5. The power actuator of claim 3, wherein said bias member is a coil spring disposed about said extensible member.

6. The power actuator of claim 2, wherein said bias member is in the compressed state when said extensible member is in the extended position, whereat said bias member exerts a bias on said extensible member to facilitate supporting weight of the closure member as the closure member moves from the closed position toward the open position.

7. The power actuator of claim 6, wherein said bias member is disposed between said gearbox housing and said proximal end of said extensible member.

8. The power actuator of claim 6, wherein said bias member is a coil spring disposed about said extensible member.

9. A motor vehicle having a closure member moveable between open and closed positions, the motor vehicle comprising:
a powered actuator for moving the closure member between the closed position and the open position, the powered actuator having:
an electric motor configured to rotate a driven shaft;
a gearbox coupled to said driven shaft;
an extensible member extending through the gearbox and having a proximal end on one side of the gearbox and a distal end on an opposite side of the gearbox, the distal end being configured to be pivotably coupled to one of a vehicle body of the motor vehicle or the closure member, the extensible member being configured to move between a retracted position relative to the gearbox, corresponding to the closed position of the closure member, and an extended position relative to the gearbox, corresponding to the open position of the closure member, in response to rotation of the driven shaft; and
a bias member configured to impart an axially directed bias on the extensible member to facilitate controlled axial movement of the extensible member, while reducing the load imparted on the electric motor and the gearbox, during powered movement of the closure member between the open and closed positions.

10. The motor vehicle of claim 9, wherein said bias member is in a compressed state when said extensible member is in one of the retracted position or the extended position, and wherein said bias member is in a decompressed state when said extensible member is in the other of the retracted position or the extended position.

11. The motor vehicle of claim 10, wherein said bias member is in the compressed state when said extensible member is in the retracted position, whereat said bias member exerts a bias on said extensible member to facilitate moving the closure member from the closed position to the open position.

12. The motor vehicle of claim 11, wherein said closure member is a liftgate.

13. The motor vehicle of claim 11, wherein said bias member is disposed between said gearbox housing and said distal end of said extensible member.

14. The motor vehicle of claim 10, wherein said bias member is in the compressed state when said extensible member is in the extended position, whereat said bias member exerts a bias on said extensible member to facilitate supporting weight of the closure member as the closure member moves from the closed position toward the open position.

15. The motor vehicle of claim 14, wherein said closure member is a tailgate.

16. The motor vehicle of claim 14, wherein said bias member is disposed between said gearbox housing and said proximal end of said extensible member.

17. The motor vehicle of claim 9, wherein the powered actuator is disposed within an internal cavity of the closure member.

18. A method of facilitating movement of a closure member between and open position and a closed position with a powered actuator having an electric motor configured to rotate a driven shaft, comprising:
coupling a gearbox to said driven shaft;
extending an extensible member through said gearbox with a proximal end of the extensible member being on one side of the gearbox and a distal end of the extensible member being on another side of the gearbox;
configuring said distal end to be pivotably coupled to one of a vehicle body or the closure member;
configuring said extensible member to move in response to rotation of the driven shaft between a retracted position, corresponding to the closed position of the closure member, and an extended position, corresponding to the open position of the closure member; and
imparting an axially directed bias on said extensible member with a bias member to facilitate controlled axial movement of said extensible member between the retracted and extended positions.

19. The method of claim 18, further including providing the bias member being configured to be compressed as the closure member is moved toward the open position.

20. The method of claim 18, further including at least one of:
providing the bias member being configured to be compressed as the closure member is moved toward the closed position; and
providing the bias member as a coil spring disposed about said extensible member.
